(19) United States
(12) Patent Application Publication
(10) Pub. No.: US 2012/0221504 A1
(43) Pub. Date: Aug. 30, 2012

(54) COMPUTER IMPLEMENTED INTELLIGENT AGENT SYSTEM, METHOD AND GAME SYSTEM

(76) Inventors: Rodolfo Rosini, London (GB); Stéphane Bura, London (GB)

(21) Appl. No.: 13/407,513

(22) Filed: Feb. 28, 2012

Related U.S. Application Data
(60) Provisional application No. 61/447,325, filed on Feb. 28, 2011.

(51) Int. Cl. G06N 5/02

(52) U.S. Cl. 706/50

(57) ABSTRACT

A Computer Implemented Intelligent Agent System, Method and Game System are disclosed. Intelligent agent systems are configured to have a long-term and a short term memory in a data repository. The data repository encodes data on a plurality of behavioural attributes for the intelligent agent, each of the plurality of behavioural attributes comprising a value within a predetermined range, the relative position of the value in the range defining the relative behavioural state of the intelligent agent. A processor is configured to execute computer program code to execute an artificial intelligence module, including computer program code configured to receive an input, computer program code configured to access the data repository in dependence on the input to obtain a state of the intelligent agent with respect to the input and, computer program code configured to process the input in dependence on the obtained state and determine an output.

### FIELD OF THE INVENTION

The present invention relates to a computer implemented game system and to a computer implemented intelligent agent system and method that is particularly applicable for use in multi-player computer games.

### BACKGROUND TO THE INVENTION

An intelligent agent is typically an entity implemented in a computer system that carries out some set of operations on behalf of a user or another program with some degree of independence or autonomy, and in so doing, employ some knowledge or representation of the user's goals or desires.

Intelligent agents tend to be very goal driven due to the very nature of systems in which they operate.

In a multi-player computer game such as those called massively multiplayer online role playing games, plotlines and major gameplay are typically offered through interaction with player and non-player characters. Non-player characters will typically have some degree of intelligence (so a guard will know when to attack a hostile character) but they do not typically exhibit independence or autonomy beyond a very narrowly scoped duty (stand at point X, patrol area Y . . . ). Even the more developed non-player characters will be heavily scripted so as to offer the same quest opportunities to players he, she or it encounters.

While significant efforts are expended in making combat with non-player characters more challenging (such as the application of Artificial Intelligence techniques to path finding and the like), they still lack any degree of autonomy or independence that you would expect of an intelligent entity.

### STATEMENT OF INVENTION

At least a portion of the steps described herein are performed by a process defined by code executing within a processor of a computer. The code can comprise software instructions that are provided to a physical memory that is accessible to the processor of the computer.

According to an aspect of the present invention, there is provided a computer implemented intelligent agent system comprising:
a data repository comprising a long-term and a short term memory, the data repository encoding data on a plurality of behavioural attributes for the intelligent agent, each of the plurality of behavioural attributes comprising a value within a predetermined range, the relative position of the value in the range defining the relative behavioural state of the intelligent agent;
a processor configured to execute computer program code for executing an artificial intelligence module, including:

computer program code configured to receive an input;

computer program code configured to access the data repository in dependence on the input to obtain a state of the intelligent agent with respect to the input; and,

computer program code configured to process the input in dependence on the obtained state and determine an output.

The state may comprises an inhibitory or excitatory modifier, the artificial intelligence module including computer program code to apply the modifier to a valuation of each of a group of outputs and to select an output from the group in dependence on its modified valuation.

Each behavioural attribute value may comprise a numeric value, wherein the artificial intelligence module includes computer program code configured to classify the input and identify one or more of the behavioural attributes in dependence on the classification, the modifier being calculated from parameters including the respective values of the identified behavioural attributes.

The data on the behavioural attributes may be encoded in the short and long term memories, the computer program code configured to access the data repository in dependence on the input to obtain a state of the intelligent agent with respect to the input including computer program code configured to access the short and long term memories to obtain data relevant to the input and determine a state in dependence on the data obtained from both the sort and long term memories.

Data on a behavioural attribute encoded in the short term memory may include data on a lifetime for the respective behavioural attribute, the intelligent agent system being arranged to delete data from the short term memory that has exceeded its respective lifetime.

The system may further comprise computer program code configured to track inputs associated with a behavioural attribute, and being configured, upon said inputs exceeding a predetermined threshold to transfer data encoded in respect of the attribute from the short term memory to the long term memory.

Each of the plurality of behavioural attributes may be encoded as a vector within an n-dimensional cube representation, the position in the cube representing the value of the attribute.

The data repository may encode data on one or more behavioural attributes in respect of each of a plurality of entities, the relative position of the value in the range defining the relative behavioural state of the intelligent agent with respect to the entity.

The input may be selected from a group including: a query; a change in state of the intelligent agent; and, a change in state in an environment of the intelligent agent.

The output may be selected from a group including: execution of computer program code to vary a graphical output of the agent to a display device; execution of computer program code to vary a graphical output of the an environment of the agent to a display device; execution of computer program code to animate a graphical output of the agent to a display device; execution of computer program code to cause outputting of audio to an audio device; execution of computer program code to change a data encoded in the short or long term memory of the intelligent agent; and, execution of computer program code to change a data encoded in the short or long term memory of another intelligent agent.

The system may further comprise an appraisal module comprising computer program code configured to classify and value an input received by the intelligent agent system and update said data repository in dependence on the classification and value of the input.

According to another aspect of the present invention, there is provided a computer implemented multiplayer game system comprising a data repository and a processor,
the data repository encoding data modelling attributes of a virtual game world and including a long-term and a short term memory for each of a plurality of intelligent agents inhabiting the virtual game world, the short and long term memories for each agent encoding data on a plurality of behavioural attributes for the intelligent agent, each of the plurality of behavioural attributes comprising a value within a predetermined range, the relative position of the value in the range defining the relative behavioural state of the intelligent agent;
the processor being configured to execute computer program code for executing an artificial intelligence module, including:

computer program code configured to receive an input;

computer program code configured to access the data repository in dependence on the input to obtain a state one of the plurality of intelligent agents with respect to the input;

computer program code configured to process the input in dependence on the obtained state and determine an output.

The game system may further comprise a data communication system arranged to communicate data on the output over a data communications network to one or more remote terminals, the data on the output being arranged to cause an output to a user at the or each remote terminal.

The data for each agent may be encoded in the data repository in dependence on a predetermined one of a plurality of complexity levels, the complexity level for an agent being determined in dependence on relative importance of the agent to the game, an agent of higher relative importance having a higher level complexity.

The number of behavioural attributes stored in the data repository for an agent may be dependent on its complexity level, a higher complexity level corresponding to a greater number of behavioural attributes.

For each of the plurality of intelligent agents the data repository may encode data on one or more behavioural attributes in respect of each of a plurality of entities, the relative position of the value in the range defining the relative behavioural state of the intelligent agent with respect to the entity.

An entity may be selected from a group including: another of the plurality of intelligent agents; data on an object in the virtual game world; and, data on an attribute of the virtual game world.

According to another aspect of the present invention, there is provided a computer implemented intelligent agent processing method comprising:
encoding, in a data repository, data on a plurality of behavioural attributes for an intelligent agent, each of the plurality of behavioural attributes comprising a value within a predetermined range, the relative position of the value in the range defining the relative behavioural state of the intelligent agent;
executing an artificial intelligence module, by a processor, including:

executing, by the processor, computer program code to receive an input;

executing, by the processor, computer program to access the data repository in dependence on the input and to obtain a state of the intelligent agent with respect to the input;

executing, by the processor, computer program code to process the input in dependence on the obtained state and determine an output.

According to another aspect of the present invention, there is provided an intelligent agent system comprising an input component, a data repository encoding a long-term and a short term memory, and an artificial intelligence module, the intelligent agent system maintaining a plurality of behavioural attributes in respect of each of a plurality of entities, each of the plurality of behavioural attributes comprising a value within a predetermined range, the relative position of the value in the range defining the relative behavioural state of the intelligent agent with respect to the entity, wherein the intelligent agent system is arranged to receive data on one or more inputs at the input component and is arranged to process the input in the artificial intelligence module in dependence on data in the short and long term data repositories and in dependence on values of one or more of said behavioural attributes to determine an action to be executed.

### BRIEF DESCRIPTION OF THE DRAWINGS

FIG. 1 is a schematic diagram of aspects of an intelligent agent system according to an embodiment of the present invention;

FIG. 2 is a schematic diagram of a computer implemented game environment utilising the intelligent agent system of FIG. 1;

FIG. 3 is a schematic diagram of a computer system implementing the intelligent agent system of FIG. 1;

FIG. 4 is a flow diagram illustrating selected steps of a method according to an embodiment of the present invention.

### DETAILED DESCRIPTION

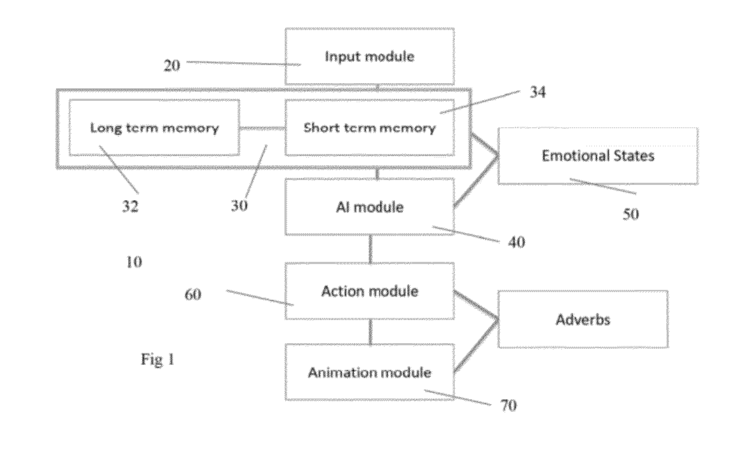

FIG. 1 is a schematic diagram of aspects of an intelligent agent system according to an embodiment of the present invention;

The intelligent agent system 10 comprises an input component 20, a data repository 30 and an artificial intelligence (AI) module 40.

The intelligent agent system 10 maintains a plurality of behavioural attributes, each of the plurality of behavioural attributes comprising a numeric value within a predetermined range, the relative position of the numeric value in the range defining the relative state of the intelligent agent with respect to the behaviour.

The intelligent agent system receives data on one or more inputs at the input component 20 and is arranged to process the input in the AI module 40 in dependence on data in the data repository 30 and in dependence on values of one or more of said behavioural attributes to determine an action to be executed.

The AI module may be a rules based decision tree, a neural network or some other AI based decision module.

The data repository 30 encodes a long and a short term memory 32, 34 for storing data associated with the intelligent agent and its experiences.

The long and short term memories for an agent are preferably linked and interact. For example, memories in long term memory associated with a behaviour trait, object or the like may have an excitatory, inhibitory or suppression effect on short term memory. The effect is used in guiding processing decisions by the Al module 40 and may also be used to determine whether or not an experience, object or the like is recorded in short term memory at all. It may also have an effect on the magnitude of behavioural values that are recorded.

Long term memory may be accessed directly by the intelligent agent system 10 or it may be configured such that it is only accessible via the short term memory. In one embodiment, regular access to long term memory may be restricted to via short term memory but in extreme circumstances (for example where the relevant behavioural attribute for an input exceeds a predetermined threshold), long term memory may be written directly. In effect, in this embodiment the short term memory acts as a buffer and only once the buffer reaches a predetermined threshold such as stimulation level, number of experiences in a particular category or the like does it overflow into long term memory and cause a data record to be created or updated in long term memory.

Preferably, data associated with events or experiences in short term memory is overwritten after a predetermined period of time (possibly as soon as the character leaves an area, or when a period of in game time passes etc.). It may also be the case that a limit on the amount of data stored in short term memory is applied such that older entries in the short term memory are overwritten by newer ones once the threshold is reached. In such an arrangement, the repetition of an experience (whether sufficient to cause the associated data in short term memory to be changed or simply enough to cause the data to have been added to short term memory if it had not already been present) may be arranged to cause the data in the short term memory to be considered “new” and not to be a candidate for overwriting.

Experiences in long term memory are preferably built up over time and typically take much longer to then be removed from long term memory. Nevertheless, data in long term memory may still have an associated age and be removed or overwritten when that age is passed.

FIG. 1 also shows a possible output of the behaviour tree in the form of a control signal to an action module 60. In this embodiment, the action module 60 is arranged to cause action with respect to the agent and/or the game world. In one example, this action may be through animation of a graphical representation of the agent or the world via commands to an animations module 70, transition of the agent to a new location in the world, etc.

It will be appreciated that the behaviour tree can be responsible for other outputs such as changes to the memories of the agent or of other agents or the feedback to other points in the behaviour tree. Similarly, the action module 60 may cause other acts such as sound output through a sound or speech module.

Behavioural attributes may be implemented in a number of different ways, although preferably they are stored as vectors with respect to an n-dimensional cube representation, the position in the cube representing the value of the attribute. Multiple values for a behavioural attribute are preferably stored so as to represent an attribute with respect to another entity. The behavioural attributes may be stored in the data repository 30 as discussed in more detail below or some other memory. The data repository may be a database or other form of memory store.

In the following discussion, a behavioural tree is implemented by the artificial intelligence module 40.

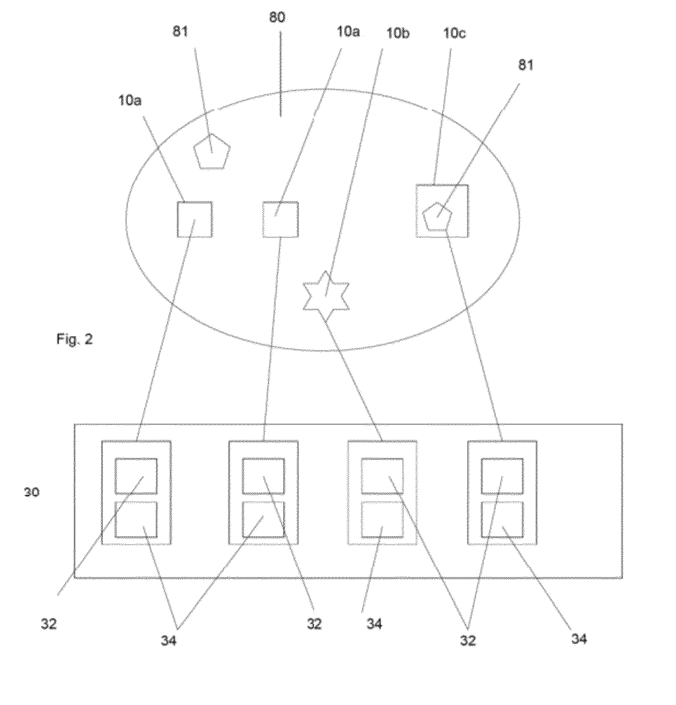

An intelligent agent 10 is configured to respond to queries instigated by its behaviour tree (BT). The example illustrated in FIG. 2 is of a point in time in a location 80, in computer implemented multiplayer game. At the location are agents 10a, 10b, and 10c and objects 81. Each agent has an associated long and short term memory 32, 34 in the data repository 30.

An agent may, for example represent a character. The BT 40 is configured to control actions and reactions of each character. In one scenario, the BT 40 may have executed a sequence of nodes that resulted in a query for the availability of nearby food for the agent labelled 10b, food objects being those labelled 81. In this case the agent's emotional reaction to each sensed object and agent is used to determine the selection of the food object to try to obtain based on the emotional reward associated with those available.

For example, the query may return the two different food objects within the radius able to be sensed by the agent 10b (the query radius). Different approaches could be made to make a decision of which object 81 the agent 10b may attempt to attain. In the simplest case, the BT can simply be used to determine like/dislike of the available food object 81 based on a simple classification, such as whether the object is fruit or vegetable or whether the item is sweet or sour and whether the attribute sweet or sour in the agent's short and long term memory has an excitatory or inhibitory effect. Likes with respect to such attributes could be modelled as a behavioural attribute (for example, a character preferring sour having a higher value for the attribute than one disliking such flavours).

In a more realistic implementation, past experiences are taken into account either with respect to the unique object/character or with objects/characters with a similar classification. For example, agent 10c may represent a guard dog and agent 10b may have a fear of dogs (or optionally of this particular dog). Such past experiences are initially stored in the short term memory and may, depending on the magnitude of the experience and other such factors, be transferred into long term memory.

In this manner, the agent 10b may, amongst others have behavioural attributes in its short term memory with respect to:

Sour: −0.2

Sweet: 0.5

Fear (of Dogs): −0.3

Thus, if the object guarded by the dog was sweet, the positive sweet modifier may be reduced due to fear of its “owner” 0.5+(−0.3)=0.2. As a result, the agent 10b is still more motivates to try to obtain the object from the dog 10c. Of course, it may be that other attributes such as a desire to avoid confrontation are also encoded in short or long term memory that also influence the respective modifiers.

Different agent models with varying complexity and memory sizes can be used for different agents. For example, stock agents 10a who do not contribute to the main plot may be modelled using a much simpler approach and minimal memory footprint compared to the agent 10b who may be central to a plot and repeatedly encountered during the evolution of the plot.

Another aspect of this pattern of memory based data storage is that the relative novelty of an object with respect to the agent can be taken into account to alter the intensity of the reaction to the object. An agent who is unused to seeing guns may react significantly to the sight of an armed friend, whereas an agent representing a gangster may be configured via his or her short and long term memories to include attributes having an inhibitory effect (reduced or no fear of guns) and therefore less likely to have a similar reaction. The final aspect that can be considered when dealing with objects is the penalty or reward associated with interactions. For example, an agent may have a strong liking for apples, but if the agent consumes an apple that is sour, it can have some modifying effect on associated attributes in long or short term memory and therefore influence subsequent desire for more apples. Dependent on the agent model, the effect may be the addition of data on the particular apple with an inhibitory value for selected attributes in the short term memory (or long term memory if the experience exceeded a predetermined threshold). For agents with basic models, it may be that no effect is recorded at all or a more general desire (for apples or fruit) is reduced in magnitude.

As will be appreciated from the above discussion, attributes can be associated with particular objects, agents and classes of object or agent depending on the complexity of the agent model. Therefore, when an object or agent is encountered, it may first be classified to identify attributes associated with that class in the short or long term memory.

In the case of inputs to the input module 20 in the form of object queries, objects in the query radius with respect to the agent are identified and processed to obtain preference values for each object in turn (highest being most preferred, lowest being least preferred). The object with the highest appraisal value is then identified for interaction. Once an object has been selected, a reference to that object is stored as a goal within the agent's short term memory as an object to be obtained. It is desirable to constrain memory usage at this point, as new objects may be perceived frequently and marked for attainment. This can be achieved by attaching an expiration value to each new object attainment goal. An update process is preferably arranged to monitor the agent's short term memory and is arranged to remove goals that have expired when it encounters them within its update loop.

Once an object is attained (typically via another node in the behaviour tree), any attainment goals relating to the object are then considered as inputs. If a specific attainment goal is found within the short term memory, the arousal value of achieving the specific goal is then processed. This arousal processing takes into account the goals for attainment of the object. There are two major reactions to consider here. The first is that the agent must consider his, her or its own reaction to the object. Typically, an agent would try to obtain objects having an arousal value indicating it would like, but if the system allows attaining of objects by other means—for example, by allowing agents to simply give objects to (or receive objects from) other agents—there may be negative consequences. An agent who obtains a ticking time bomb should definitely not be happy about its attainment. The second reaction to the attainment of an object is with respect to other agents. An agent who obtains an object that is highly desired by another agent, depending on whether the other agent is liked or disliked, may feel guilty or happy for acquiring the item, respectively. Alternatively, if no specific attainment goals are stored in the short term memory, the system can simply consider the attainment goals of other agents for the object, or can consider the general valence of the object and react based on positive or negative feelings about it. For example, an object that is attained may allow the agent to accomplish a goal for another agent if the object is given to him. In this case, the system may create a goal to pass on the object if, in doing so, it achieves a goal of an agent we have positive affect towards, or the system may decide to keep or dispose of the object if it denies a goal of an agent we have negative effect towards.

Preferred embodiments of the present invention preferably enable behavioural attributes including emotion, mood, and personality to be modelled and applied to intelligent agents.

The aspects of personality, mood, and emotion can be differentiated primarily by the time scale required for change.

As the broadest scope, an agent's personality would be conveyed through aspects that are specific to that agent as a whole. These aspects either would not change or would change minimally over a long period of time and may be encoded as attributes in long term memory or in some unchanging memory in the data repository 30. For example, an agent might have an innate preference for a specific type of object and a hatred of another type of object. These are characteristics that are unlikely to change over the lifetime of a person and, as such, would be modelled with permanent or near-permanent values in an agent. That is, outside influences would not affect these values much at all.

Mood, on the other hand, may change in a period of days, weeks, or even longer in extreme circumstances. Mood can certainly be linked in some aspects to personality. If an agent's personality has an inclination for either the upbeat or the dour, the frequency and duration of related moods would be affected accordingly. Unlike personality, moods can be affected by prolonged circumstances. World events of significant magnitude and/or frequent occurrence that the agent perceives can have an effect on the longer-term emotional state of the agent.

In the short term, characters can have emotions. While similar to mood in that they can be affected by circumstances, emotions are more immediate in response and generally more transient. For example, receiving a gift from another agent may make the agent happy immediately. Depending on the magnitude of the gift (considering the factors listed above for example), this feeling may wane over the course of minutes or hours.

Just as personality and mood are related, mood and emotion have an interrelationship. Going in one direction, the agent's prevailing mood sets a baseline for emotions that occur during that mood. If the agent is depressed due to a series of bad, long-term circumstances, receiving a gift will only have a minimal effect. Additionally, the duration of the emotional boost may be shortened. On the other hand, an agent in a good mood may be more likely to “shrug off” an event that may otherwise be perceived as negative and normally would have elicited a negative emotion.

Working in the other direction, repeated and/or prolonged emotions may have a cumulative effect that serves to change the underlying mood of the agent. For example, repeated receipts of gifts or other positive experiences may, over time, have a beneficial effect on the mood of the agent. Again, the magnitude and duration of the emotion is the important factor. Occasional minimal positive emotions will have a lesser effect on the agent's mood than more frequent or more significant emotional experiences.

Each of the three aspects, personality, mood, and emotion, can have multiple axes and scales as required by the design of the agent. Each axis can represent a different measure of personality, a different mood, or a different type of emotion. Each can then be represented as values on a scale ranging between a defined minimum and maximum determined by what is necessary to appropriately express the type of value. For example, a general mood descriptor with opposite poles of “sad” and “happy” might be reflected in a range of −1.0 to +1.0 respectively. An axis that reflects simply the amount of “fear” felt by a character might be represented by a value of 0.0 to 1.0.

The instantaneous state of each of the various axes in the aspects of personality, mood, and emotion, can be incorporated into decisions by the agents. These factors may color the agents preferences for the object(s) or agent(s) in question. That is, the base reaction to a given situation may be affected by the “state of mind” of the agent at the time. For example, while an agent might normally be pleased to receive a desired object from a well-liked friend, a poor mood or recent bad emotion may dampen the reception of the gift.

Given the above factors, the long-term behaviour of an agent will be based on the combination of sensing new events, remembering old events, and filtering both through the agent's personality, mood, and emotion states. This requires that an agent categorizes and stores its experiences throughout its life.

Naturally, the best fidelity of an agent's memory would be to note, categorize, and remember everything that it senses. However, it must also be taken into account that no system has unlimited resources. A single player game can be accurately modelled and memory requirements predicted. A massively multiplayer role playing game, however, presents different challenges. While it is desirable to model behaviour and emotion for interaction between each entity (player controlled or intelligent agent), it will be appreciated that this may not be scaleable for large numbers of entities.

For example, if you attempted to model possible behavioural states/emotions between each player:player player:agent agent:agent (and potentially combinations of player/agent/object states and emotions), the storage overhead scales quickly to be unachievable (And unprocessable even if it could be stored).

In one embodiment of the present invention, intelligent agents are classified into a plurality of categories, behavioural states of individual intelligent agents in a primary category being modelled in full, behavioural states in lower categories either being modelled on a reduced level such that behavioural states with respect to agents of other categories or characters are modelled in full (and so can be updated for individual agents of that class following interactions) but behavioural states between agents of the same or lower category are fixed.

For example—a primary non-player character that is central to a plotline would fall into the primary category and have behavioural states modelled in full. Interactions with player characters and other intelligent agents of the primary or lower category would be reflected by the behavioural states. A lower category non-player character (such as a guard or other ‘filler’) would consistently act the same to other non-player characters of the same or lower level (so would greet and treat other guards in the same way, irrespective of what might have happened earlier) but would react differently to higher level non-player and player characters due to modelling of behavioural states with respect to these entities.

Such a model (known as the Bura Equation) would result in the following memory overhead requirement:

M=memory

### Social

P=Number of Player Characters (capped by the number of players)

Rp =Relationship fields for Player Characters

### World

G=Number of Non Player Character Groups (capped by design)

Rg=Relationship field for Non Player Character Groups

### Story

I=Number of interacting Non Player Character (capped by design, higher means richer more realistic world, e.g. more stories)

Pi=Number of perceived interactions

M=P^{Rp}+G^{Rg}+I^{Pi}

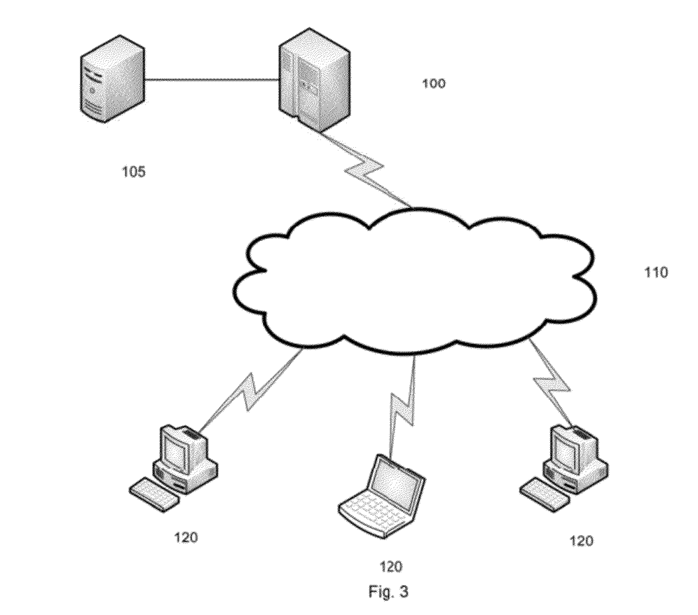

FIG. 3 is a schematic diagram of a computer system implementing the intelligent agent system of FIG. 1.

A massively multiplayer role playing game is run and maintained on a server 100. The role playing game is implemented as a graphically rendered virtual world. Inhabitants of the virtual world are each implemented as a virtual agent system as discussed above with reference to FIG. 1.

Client machines 120 access the role playing game at the server 100 via a network 110. The client machine 120 renders a graphical visualisation of a portion of the virtual world and communicates with the server 100 to enable a user to interact and move within the world.

A data repository 105 is maintained that models attributes of the virtual world including behavioural attributes of inhabitants of the world. When a player character controlled by a user at a client machine 120 encounters another inhabitant, behavioural attributes of the player character with respect to the other inhabitant are obtained and used to modify actions available to the player character. Similarly, behavioural attributes of the other inhabitant with respect to the player character are obtained and used to modify actions available to the other inhabitant.

It will be appreciated that modelling of interactions with events can be done in a similar manner.

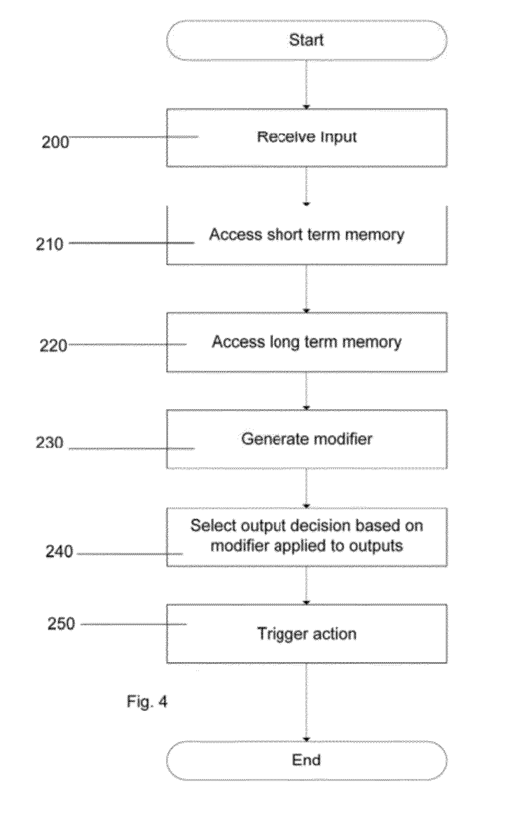

FIG. 4 is a flow diagram illustrating a method of processing queries according to an embodiment of the present invention.

In step 200, an input is received at the input module 20 of the agent 10. In step 210, the Al module 40 of the agent 10 accesses the data repository 30 and in particular the agent's short term memory to identify behavioural values and other memories of relevance to the query. In step 220, behavioural values and other memories from the long term memory are accessed and in step 230 the values from short and long term memories are combined to generate an inhibitory or excitatory modifier. The Al module determines an output (or determines no output) in dependence on the data from the input and on the generated modifier in step 240.

In step 250, an output of the Al module 40 triggers an action by the action module 60 and, optionally, an animation by the animation module 70.

In a preferred embodiment, the intelligent agent system 10 may be coupled to the in-game representation of the agent and arranged as at least a part of the action to modify agent attributes such as posture, gesture, gaze, gait, behaviour, and memory. In this manner, for example, the posture of an agent may be modified depending on whether it is happy to see a character or intends to do them harm.

It will be appreciated that the data repository may take various forms including a central or distributed file store, database (such as SQL or other relational or non-relational database types). It may be implemented using storage devices such as hard disks, random access memories, solid state disks or any other forms of storage media. It will also be appreciated that the processor discussed herein may represent a single processor or a collection of processors acting in a synchronised, semi-synchronised or asynchronous manner. For example, a master server system may maintain the gaming world and be responsible for interaction between fully autonomous agents whilst a player's local PC or other computing device may be the “processor” responsible for processing associated with the player's agent character. Alternatively, the central system may be responsible for processing decisions for all agents and player terminals may be dumb input/output devices.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer implemented intelligent agent system comprising:
a data repository comprising a long-term and a short term memory, the data repository encoding data on a plurality of behavioural attributes for the intelligent agent, each of the plurality of behavioural attributes comprising a value within a predetermined range, the relative position of the value in the range defining the relative behavioural state of the intelligent agent;
a processor configured to execute computer program code for executing an artificial intelligence module, including:
computer program code configured to receive an input;
computer program code configured to access the data repository in dependence on the input to obtain a state of the intelligent agent with respect to the input; and,
computer program code configured to process the input in dependence on the obtained state and determine an output.

2. The computer implemented intelligent agent system of claim 1, wherein state comprises an inhibitory or excitatory modifier, the artificial intelligence module including computer program code to apply the modifier to a valuation of each of a group of outputs and to select an output from the group in dependence on its modified valuation.

3. The computer implemented intelligent agent system of claim 2, wherein each behavioural attribute value comprises a numeric value, wherein the artificial intelligence module includes computer program code configured to classify the input and identify one or more of the behavioural attributes in dependence on the classification, the modifier being calculated from parameters including the respective values of the identified behavioural attributes.

4. The computer implemented intelligent agent system of claim 1, wherein the data on the behavioural attributes is encoded in the short and long term memories, the computer program code configured to access the data repository in dependence on the input to obtain a state of the intelligent agent with respect to the input including computer program code configured to access the short and long term memories to obtain data relevant to the input and determine a state in dependence on the data obtained from both the sort and long term memories.

5. The computer implemented intelligent agent system of claim 4, wherein data on a behavioural attribute encoded in the short term memory includes data on a lifetime for the respective behavioural attribute, the intelligent agent system being arranged to delete data from the short term memory that has exceeded its respective lifetime.

6. The computer implemented intelligent agent system of claim 4, further comprising computer program code configured to track inputs associated with a behavioural attribute, and being configured, upon said inputs exceeding a predetermined threshold to transfer data encoded in respect of the attribute from the short term memory to the long term memory.

7. The computer implemented intelligent agent system of claim 1, wherein each of the plurality of behavioural attributes is encoded as a vector within an n-dimensional cube representation, the position in the cube representing the value of the attribute.

8. The computer implemented intelligent agent system of claim 7, wherein the data repository encodes data on one or more behavioural attributes in respect of each of a plurality of entities, the relative position of the value in the range defining the relative behavioural state of the intelligent agent with respect to the entity.

9. The computer implemented intelligent agent system of claim 1, wherein the input is selected from a group including: a query; a change in state of the intelligent agent;
and, a change in state in an environment of the intelligent agent.

10. The computer implemented intelligent agent system of claim 1, wherein the output is selected from a group including: execution of computer program code to vary a graphical output of the agent to a display device; execution of computer program code to vary a graphical output of the an environment of the agent to a display device; execution of computer program code to animate a graphical output of the agent to a display device; execution of computer program code to cause outputting of audio to an audio device; execution of computer program code to change a data encoded in the short or long term memory of the intelligent agent;
and, execution of computer program code to change a data encoded in the short or long term memory of another intelligent agent.

11. The computer implemented intelligent agent system of claim 1, further comprising an appraisal module comprising computer program code configured to classify and value an input received by the intelligent agent system and update said data repository in dependence on the classification and value of the input.

12. A computer implemented multiplayer game system comprising a data repository and a processor,
the data repository encoding data modelling attributes of a virtual game world and including a long-term and a short term memory for each of a plurality of intelligent agents inhabiting the virtual game world, the short and long term memories for each agent encoding data on a plurality of behavioural attributes for the intelligent agent, each of the plurality of behavioural attributes comprising a value within a predetermined range, the relative position of the value in the range defining the relative behavioural state of the intelligent agent;
the processor being configured to execute computer program code for executing an artificial intelligence module, including:
computer program code configured to receive an input;
computer program code configured to access the data repository in dependence on the input to obtain a state one of the plurality of intelligent agents with respect to the input;
computer program code configured to process the input in dependence on the obtained state and determine an output.

13. The computer implemented multiplayer game system of claim 12, further comprising a data communication system arranged to communicate data on the output over a data communications network to one or more remote terminals, the data on the output being arranged to cause an output to a user at the or each remote terminal.

14. The computer implemented multiplayer game system of claim 12, wherein the data for each agent is encoded in the data repository in dependence on a predetermined one of a plurality of complexity levels, the complexity level for an agent being determined in dependence on relative importance of the agent to the game, an agent of higher relative importance having a higher level complexity.

15. The computer implemented multiplayer game system of claim 14, wherein the number of behavioural attributes stored in the data repository for an agent is dependent on its complexity level, a higher complexity level corresponding to a greater number of behavioural attributes.

16. The computer implemented multiplayer game system of claim 12, wherein for each of the plurality of intelligent agents the data repository encodes data on one or more behavioural attributes in respect of each of a plurality of entities, the relative position of the value in the range defining the relative behavioural state of the intelligent agent with respect to the entity.

17. The computer implemented multiplayer game system of claim 16, wherein an entity comprises another of the plurality of intelligent agents.

18. The computer implemented multiplayer game system of claim 16, wherein an entity comprises data on an object in the virtual game world.

19. The computer implemented multiplayer game system of claim 16, wherein an entity comprises data on an attribute of the virtual game world.

20. A computer implemented intelligent agent processing method comprising:
encoding, in a data repository, data on a plurality of behavioural attributes for an intelligent agent, each of the plurality of behavioural attributes comprising a value within a predetermined range, the relative position of the value in the range defining the relative behavioural state of the intelligent agent;
executing an artificial intelligence module, by a processor, including:
executing, by the processor, computer program code to receive an input;
executing, by the processor, computer program to access the data repository in dependence on the input and to obtain a state of the intelligent agent with respect to the input;
executing, by the processor, computer program code to process the input in dependence on the obtained state and determine an output.
